(19) United States
(12) Patent Application Publication
(10) Pub. No.: US 2010/0076736 A1
(43) Pub. Date: Mar. 25, 2010

(54) STATISTICAL SPICE MODEL PARAMETER CALCULATION METHOD, AND STATISTICAL SPICE MODEL PARAMETER CALCULATION DEVICE AND PROGRAM

(75) Inventor: TAKASHI SHIMIZU, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/564,932

(22) Filed: Sep. 23, 2009

(30) Foreign Application Priority Data
Sep. 24, 2008 (JP) 2008-244394

(51) Int. Cl. G06F 17/50; G06F 17/10

(52) U.S. Cl. 703/2; 703/14

(57) ABSTRACT

A statistical SPICE model parameter calculation method in which it is possible to create a variation model having high accuracy and size dependency. A principal component analysis is performed, for respective device sizes, of a measurement of an element characteristic value of a semiconductor device on which multipoint measurement is performed (principal component analysis process). A statistical SPICE model parameter that reproduces variation of an element characteristic value for a plurality of device sizes is calculated based on a result of the principal component analysis obtained for each of the device sizes and predetermined device size dependency (parameter calculation process).

### REFERENCE TO RELATED APPLICATION

This application is based upon and claims the benefit of the priority of Japanese patent application No. 2008-244394, filed on Sep. 24, 2008, the disclosure of which is incorporated herein in its entirety by reference thereto.

### TECHNICAL FIELD

The present invention relates to a statistical SPICE (Simulation Program with Integrated Circuit Emphasis) model parameter calculation method, a statistical SPICE model parameter calculation device, a statistical SPICE model parameter calculation program, and a circuit simulation method (device).

### BACKGROUND

Several methods of calculating parameters using circuit simulation, which assume the existence of variation in device characteristics, have been proposed. For example, Patent Document 1 discloses a method of calculating characteristic representative values from measured data of a plurality of elements, calculating, for a residual sum of squares of a function f corresponding to the measured data and these characteristic representative values, a representative parameter matrix represented by a linear sum of the characteristic representative values by applying a least squares method, and calculating a parameter variance matrix by applying the law of error propagation to this representative parameter matrix.

Furthermore, Patent Document 2 discloses a variation simulation system that can determine a variation model from a statistical property of a device characteristic, and can perform circuit simulation. The document discloses a method of fitting a principal component direction of the model so as to match a principal component direction of measured data, and of creating a statistical model including correlations.

Non-Patent Document 1 describes Pelgrom's Law in which random variations are proportional to a square root reciprocal of a device gate area.

### [Patent Document 1]

JP Patent Kokai Publication No. JP-P2007-280123A

### [Patent Document 2]

International Patent Publication No. 2006/016611 (Pamphlet)

### [Non-Patent Document 1]

M. Pelgrom, A. Duinmaijer and A. Welbers, “Matching properties of MOS transistors”, IEEE Journal of Solid-State Circuits, Vol. 24, No. 5, pp. 1433, October 1989.

### SUMMARY

The entire disclosure of Patent Documents 1 and 2, and Non-Patent Document 1 are incorporated herein by reference thereto.

In the method of Patent Document 1, there is no guarantee of having a model that can reproduce variations for an actual object in which variation causes are complexly intertwined. For example, it is possible to measure variation of channel length L and ON current value Ion, but it is difficult to enter these consistently into one statistical model. If a variation value of the channel length L is entered into the model as it is, a model is possible having a strong correlation with the channel length L, but cases have been observed in which the variations of the actual object have a stronger correlation with impurity variations than the channel length L. Even if Monte Carlo simulation is performed with a model having this type of variation that differs from the actual object, a correct result cannot be obtained.

On the other hand, according to a method of Patent Document 2, there is a possibility of being able to reproduce variations for an actual object in which variation causes are complexly intertwined, but there is a problem in that, among devices used in a circuit, it is not possible to give variations appropriate to a device of a different size to the measured device. A reason for this is that in the method of Patent Document 2, since a statistical model is created for a device of a specific size, there is no guarantee with regard to variations given to devices of other sizes.

According to a first aspect of the present invention, there is provided a statistical SPICE model parameter calculation method that includes: a principal component analysis process of performing a principal component analysis, for each device size, of a measurement of an element characteristic value of a semiconductor device on which multipoint measurement is performed, and a parameter calculation process of computing a statistical SPICE model parameter that reproduces variation of an element characteristic value for a plurality of device sizes, based on a result of the principal component analysis obtained for each of the device sizes, and a predetermined device size dependency.

Here, Principal Component Analysis (PCA) is an analysis method of describing an original measured value characteristic by variable quantity, abstracting as much information (a distribution) as possible holding original measured values, with no correlation between variable quantities, from measurement of a large number of variable quantities. A specific example is described later.

According to a second aspect of the present invention, there is provided a statistical SPICE model parameter calculation device that includes: a principal component analysis unit that performs principal component analysis, for respective device sizes, of a measurement of an element characteristic value of a semiconductor device on which multipoint measurement is performed, and a parameter calculation unit that calculates a statistical SPICE model parameter which reproduces variation of an element characteristic value for a plurality of device sizes, based on a result of the principal component analysis obtained for each of the device sizes, and a predetermined device size dependency.

According to a third aspect of the present invention, there is provided a statistical SPICE model parameter calculation program that executes on a computer: a process of performing a principal component analysis, for respective device sizes, of a measurement of an element characteristic value of a semiconductor device on which multipoint measurement is performed, and a process of computing a statistical SPICE model parameter that reproduces variation of an element characteristic value for a plurality of device sizes, based on a result of the principal component analysis obtained for each of the device sizes, and a predetermined device size dependency.

The meritorious effects of the present invention are summarized as follows.

According to the present invention, it is possible to create a variation model having high accuracy and size dependence. A reason for this lies in having a configuration that performs principal component analysis for each device size and also calculates a statistical SPICE model parameter having size dependency.

### BRIEF DESCRIPTIONS OF THE DRAWINGS

FIG. 1 is a block diagram representing a configuration of a statistical SPICE model parameter calculation device according to a first exemplary embodiment of the present invention.

FIG. 2 is a flowchart for describing operation of a statistical SPICE model parameter calculation device according to the first exemplary embodiment of the present invention.

FIG. 3 is a drawing for describing adjustment processing in a principal component direction.

FIG. 4 is a drawing showing a result of simulation without performing the adjustment processing in a principal component direction.

FIG. 5 is a drawing for describing the adjustment processing in a principal component direction.

FIG. 6 is a drawing showing a result of simulation after implementing the adjustment processing in a principal component direction.

FIG. 7 is a drawing in which variation (model) reproduced using a method of the first exemplary embodiment of the present invention and distribution of measured data are plotted for each principal component and device size.

FIG. 8 is a drawing in which variation (model) reproduced using a method (no size correction) of Patent Document 2 and distribution of measured data are plotted for each principal component and device size.

FIG. 9 is a drawing in which variation (model) reproduced using a method (size corrected) of Patent Document 2 and distribution of measured data are plotted for each principal component and device size.

FIG. 10 is a drawing showing a result for which simulation was performed using results of FIG. 7 to FIG. 9.

FIG. 11 is a block diagram representing a configuration of a statistical SPICE model parameter calculation device according to a second exemplary embodiment of the present invention.

FIG. 12 is a drawing for describing a principle of a statistical SPICE model parameter calculation device according to a third exemplary embodiment of the present invention.

### PREFERRED MODES

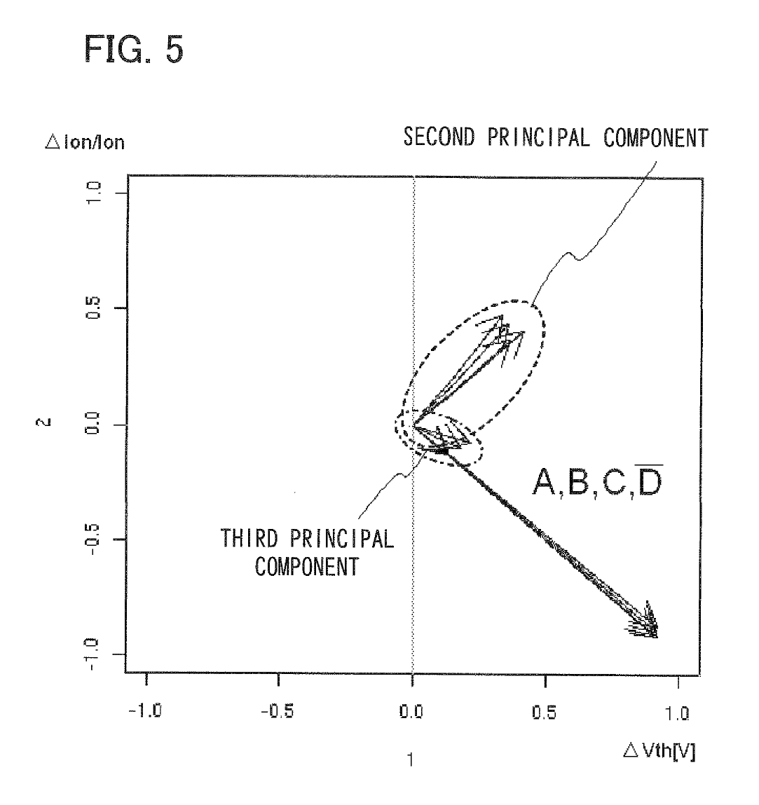

First, an outline of a statistical SPICE model parameter calculation method of the present invention is described. To begin with, multipoint measurement is performed on an element characteristic value of a semiconductor device (for example, ON current value Ion, threshold voltage Vth, intermediate drain current, or the like). A statistical SPICE model parameter calculation device performs principal component analysis of the measurement for each device size (A to D) (refer to FIG. 5).

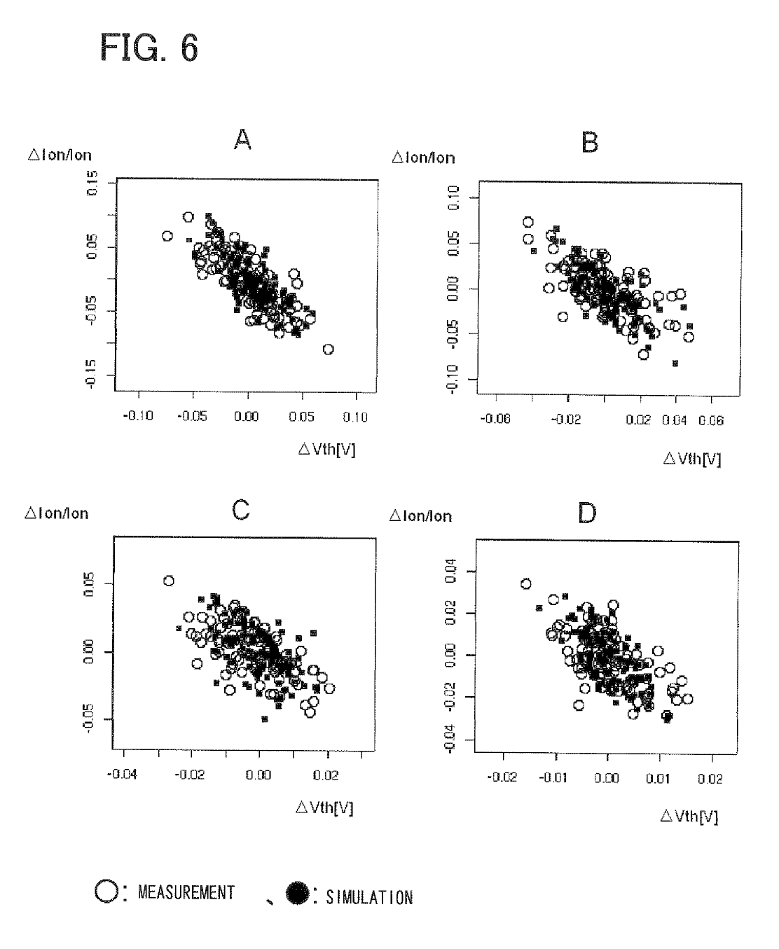

A predetermined device size dependency (for example, being proportional to a square root reciprocal of a device gate area LW (Non-Patent Document 1)) is applied to a result of the principal component analysis obtained for each of the abovementioned device sizes, and a statistical SPICE model parameter that can reproduce variation of an arbitrary element characteristic value for an arbitrary device size is calculated (refer to FIG. 6).

In this way, the statistical SPICE model parameter that can reproduce variation of an arbitrary element characteristic value for a plurality of device sizes, including a device size that has not been measured (C, in the lower left of FIG. 6) can be obtained, and it is possible to perform effective simulation.

Next, a detailed description is given concerning preferable exemplary embodiments of the present invention, making reference to the drawings.

### First Exemplary Embodiment

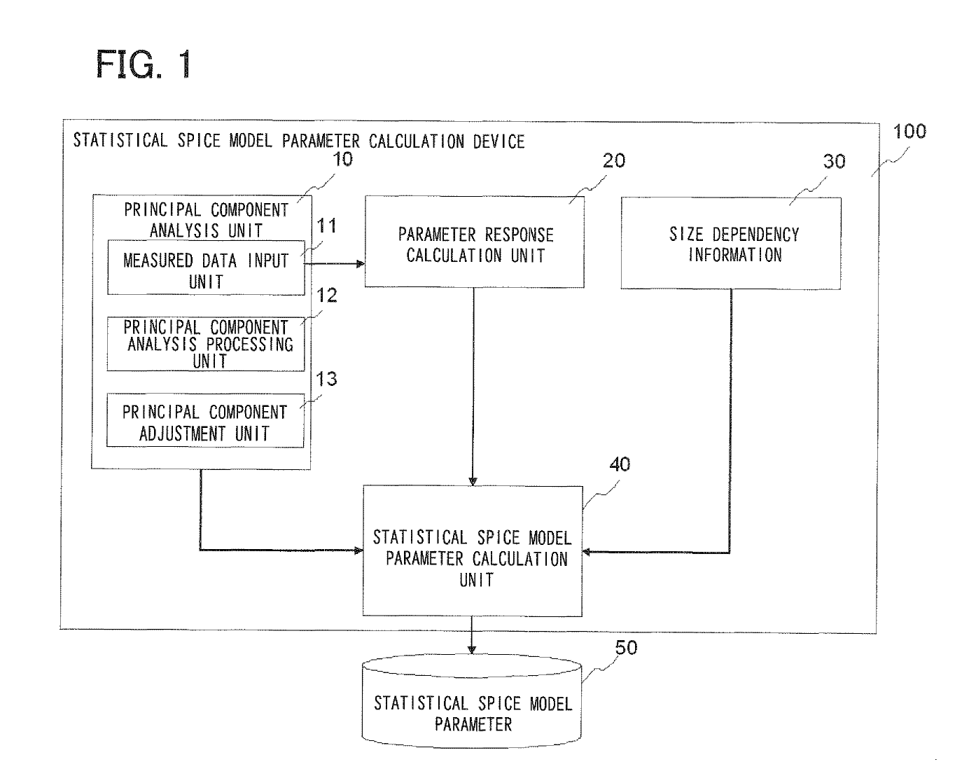

FIG. 1 is a block diagram representing a configuration of a statistical SPICE model parameter calculation device according to a first exemplary embodiment of the present invention. FIG. 1 shows the statistical SPICE model parameter calculation device 100 that is provided with a principal component analysis unit 10, a parameter response calculation unit 20, size dependency information 30, and a statistical SPICE model parameter calculation unit 40.

The principal component analysis unit 10 is configured to include a measured data input unit 11, a principal component analysis processing unit 12, and a principal component adjustment unit 13.

Measured data of multipoint measurement of a wafer or the like, selected as a measurement target, is inputted to the measured data input unit 11. In a case of focusing on extracting a random variation parameter, in order to exclude effects of variations outside of the random variation, it is desirable to have as a target for measurement a pattern in which the same devices are densely packed in a small area, or to take 1/√2 of a difference between 2 adjacent characteristics.

The principal component analysis processing unit 12 performs principal component analysis of measured data inputted by the measured data input unit 11, according to device size. In the present exemplary embodiment, element characteristics of a certain device size (channel length L, channel width W; below, “L, W” represent a device of channel length L and channel width W) are written as Iᵢ(L, W), i=1 . . . n. Here, n is the type of element characteristic, for example, I₁(L, W) represents an ON current value Ion for a device size L, W, and I₂(L, W) represents a threshold voltage Vth for a device size L, W.

The principal component adjustment unit 13, when modeling is performed using a result of principal component analysis according to device size by the principal component analysis processing unit 12, performs adjustment processing of changing orientation of principal component direction so that inconsistency does not occur, or of changing principal component order.

The parameter response calculation unit 20 uses a SPICE model used in simulation, to calculate a response in a case where SPICE parameters (for example, VTHO, UO) that create variation are minutely changed.

The size dependency information 30 is information defining dependency due to device size of a parameter. For example, for a certain parameter, it is possible to use Pelgrom's Law of proportionality to a square root reciprocal of a device gate area. For a parameter having a complex size dependency characteristic, it is possible to use a function of size (L, W), giving consideration to higher order terms, as described below.

The statistical SPICE model parameter calculation unit 40 uses the abovementioned adjusted principal component analysis result, and parameter response and size dependency information, to calculate a statistical SPICE model parameter that can reproduce variation of element characteristic values of a plurality of device sizes including not only a measured device size but also a non-measured device size.

Moreover, the statistical SPICE model parameter calculation device 100 exemplified in FIG. 1 can be realized by a computer provided with a CPU, a storage device, an output device, and the like. Furthermore, the abovementioned principal component analysis unit 10 and the statistical SPICE model parameter calculation unit 40 can be realized by reading a program that executes operations described below, from the storage device of the computer, to be executed in the CPU.

Next, a detailed description is given concerning operation of the statistical SPICE model parameter calculation device 100 of the present exemplary embodiment, making reference to the drawings.

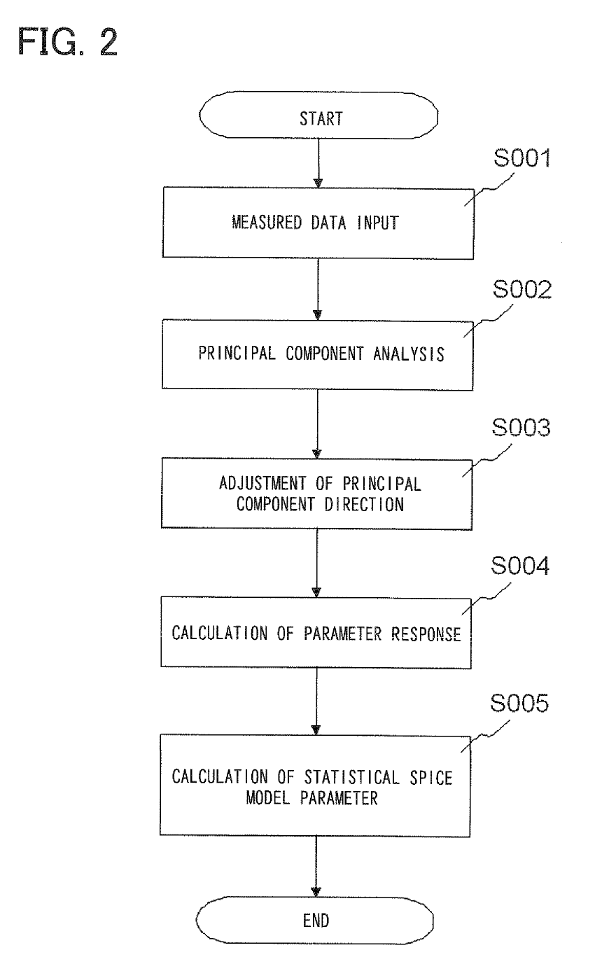

FIG. 2 is a flow chart representing one example of processing executed in the statistical SPICE model parameter calculation device 100 of the present exemplary embodiment. Below, making reference to FIG. 2, a description is given of each process executed by the statistical SPICE model parameter calculation device 100 and of each item concerning advance preparation necessary for each process.

First, measured data Iᵢ(L, W), i=1 . . . n of multipoint measurement from a wafer or the like, which has been selected as a target for measurement, is inputted to the measured data input unit 11 (step S001).

Next, the principal component analysis processing unit 12 performs principal component analysis on the measured data Iᵢ(L, W), i=1 to n (step S002).

### Principal Component Analysis

A description concerning principal component analysis is given here. First, a covariance matrix of measured data Iᵢ(L, W), i=1 . . . n is calculated according to size L, W. The covariance matrix of measured data V(L, W) is given by the following expression. Here, μᵢ is an expected value of the measured data Iᵢ(L, W) according to size.

$$V ( L , W ) = [ \begin{matrix}E [ \begin{matrix}{I}_{1} ( ( L , W ) - {μ}_{1} ) \\ {I}_{1} ( ( L , W ) - {μ}_{1} )\end{matrix} ] & ⋯ & ⋯ & E [ \begin{matrix}{I}_{1} ( ( L , W ) - {μ}_{1} ) \\ {I}_{n} ( ( L , W ) - {μ}_{n} )\end{matrix} ] \\ E [ \begin{matrix}{I}_{2} ( ( L , W ) - {μ}_{2} ) \\ {I}_{1} ( ( L , W ) - {μ}_{1} )\end{matrix} ] & ⋯ & ⋯ & E [ \begin{matrix}{I}_{2} ( ( L , W ) - {μ}_{2} ) \\ {I}_{n} ( ( L , W ) - {μ}_{n} )\end{matrix} ] \\ ⋮ & ⋮ & ⋱ & ⋮ \\ E [ \begin{matrix}{I}_{1} ( ( L , W ) - {μ}_{1} ) \\ {I}_{n} ( ( L , W ) - {μ}_{n} )\end{matrix} ] & ⋯ & ⋯ & E [ \begin{matrix}{I}_{n} ( ( L , W ) - {μ}_{n} ) \\ {I}_{n} ( ( L , W ) - {μ}_{n} )\end{matrix} ]\end{matrix} ] \qquad Formula 1$$

Next, the abovementioned covariance matrix V(L, W) is diagonalized. Since the covariance matrix V(L, W) as in the abovementioned Formula 1 is a symmetric matrix, diagonalization is possible as in the following expression using an orthogonal matrix. In the following, a transpose of a matrix A is expressed as A^{T}.

V(L,W)=U(L,W)Σ(L,W)²U(L,W)^{T} Formula 2

If U(L, W) of the abovementioned Formula 2 is written as a 1-row, n-column matrix (e₁, e₂, . . . , eₙ), the abovementioned Formula 2 indicates performing principal component analysis of variation in a principal component direction e₁, e₂, . . . , eₙ.

Here, Σ(L, W) is a diagonal matrix having a square root of an eigenvalue as a diagonal component, and can be written as Σ=diag(σ₁, σ₂, . . . , σₙ). At this time, σᵢ represents standard deviation of variation along each principal component direction.

Furthermore, the abovementioned Formula 2 is of quadratic form, and an operation of changing signs of any column of U(L, W)=(e₁, e₂, . . . , eₙ) is possible. Moreover, it is also possible to perform an operation of simultaneously switching columns of U(L, W) and order of Σ(L, W). Using these, by switching columns of a column vector U(L, W) so that σᵢ of Σ(L, W) is arranged in descending order, the principal component analysis for size L, W, is completed.

By performing the abovementioned principal component analysis for each device size, U(L, W) and Σ(L, W) for each device size are calculated.

### Adjustment of Principal Component Direction

Next, the principal component adjustment unit 13 examines a result of the principal component analysis outputted from the principal component analysis processing unit 12, and performs adjustment if necessary (step S003). A description is given below concerning the adjustment processing of the principal component analysis result.

It is considered that with devices manufactured by the same process, if the sizes are close, physical causes of variation are similar, and the principal component directions resemble each other. However, a case may occur where signs of principal component direction change according to device size. This is due to it being possible to change the sign of an arbitrary column of U(L, W)=(e₁, e₂, . . . , eₙ) as described previously. Furthermore, sensitivity of variations may change according to device size, and order of principal components may change.

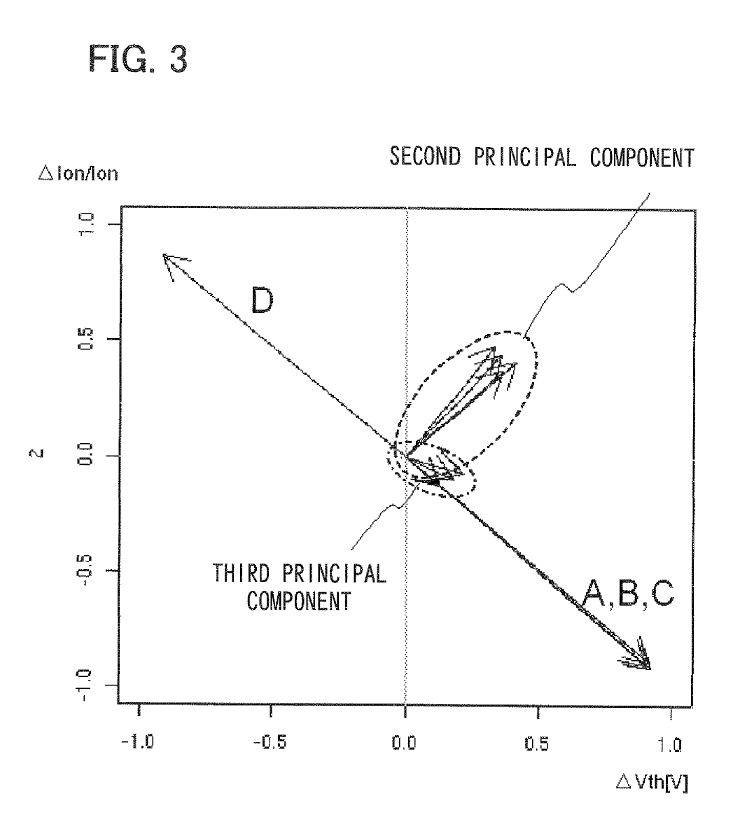

FIG. 3 is a drawing for describing a case where signs of the abovementioned principal component direction are different. The arrows in the drawing represent standardized principal component directions of device sizes A to D. In the example of FIG. 3, a first principal component direction of the device size D is opposite to first principal component directions of the device sizes A to C.

In this way if a model is created using a size dependency expression described later from principal component analysis results in which order differs or signs of principal component directions are different, since modeling is performed so as to interpolate between sizes in which signs change, it is not possible to make a practical model.

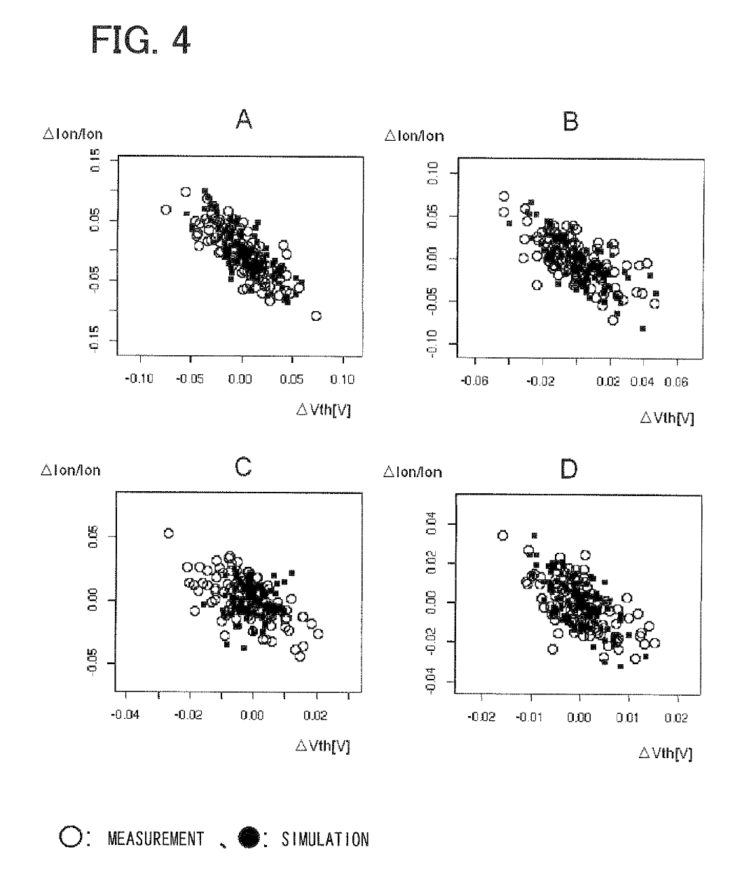

FIG. 4 shows results for which models are formed using A, B, and D, among the principal component analysis results of FIG. 3, and simulation is performed. Referring to FIG. 4, it may be understood that for device sizes A, B, and D, dispersion of simulation results for which black disks are plotted, and of measured data for which white disks are plotted approximately match and variations are well re-produced. However, in a region in which the black disks of device size C are plotted, the first principal component direction collapses, and also variations of the measured data do not match.

Accordingly, the principal component adjustment unit 13 examines a result of the principal component analysis outputted by the principal component analysis processing unit 12 as described below.

First, U(L, W)=(e₁(L, W), e₂(L, W), . . . , eₙ(L, W)) is considered to be arranged as a column vector, and it is confirmed that, between devices having adjacent device sizes, i-th column vectors eᵢ(L, W) have close directions. For example, by calculating an inner product of the arrows A, B, C, and D of FIG. 3, it is possible to judge whether or not the directions are close.

If the inner product calculated as described above is 0 or close to 0, it is considered that the order of the principal components is switched. Furthermore, if the inner product calculated as described above has a negative value, the signs among adjacent devices are different.

If the inner product of adjacent size devices as described above is 0 or a value close to 0, the principal component adjustment unit 13 switches order so that an absolute value of the inner product is largest. Next, the principal component adjustment unit 13 reverses a sign of a principal component direction for which the inner product is negative.

The abovementioned adjustment is executed by multiplying U(L, W) Σ(L, W) of a corrected device by a principal component adjustment matrix T(L, W) from the right. For example, a principal component adjustment matrix T(L, W), when the first principal component sign is reversed, and order of the second and third principal components is switched, is represented by the following expression.

$$T ( L , W ) = [ \begin{matrix}- 1 & 0 & 0 \\ 0 & 0 & 1 \\ 0 & 1 & 0\end{matrix} ] \qquad Formula 3$$

The above described Formula 2 can be re-written as in the following expression, using the abovementioned principal component adjustment T(L, W).

V(L,W)=U(L,W)Σ(L,W)T(L,W)T(L,W)^{T}Σ(L,W)^{T}U(L,W)^{T} Formula 4

The abovementioned examination and adjustment processing examines whether or not there is an inconsistency between sizes, in results of the principal component analysis of each device size, and if there is an inconsistency, corresponds to an operation of selecting a principal component adjustment matrix T(L, W) that can eliminate the inconsistency.

FIG. 5 represents a state in which the sign of the first principal component direction of device size D in FIG. 3 is reversed.

FIG. 6 shows results for which models are formed using A, B, and D, among the principal component analysis results of FIG. 5, and simulation is performed. Referring to FIG. 6, it is understood that for device size C, different from FIG. 4, dispersion if well reproduced.

### Creation of a Matrix U Bringing Together Various Sizes

The matrix U can be obtained by arranging vertically, in device size order (assuming N sizes), U(L, W) Σ(L, W) T(L, W) that have been obtained after adjustment among the abovementioned adjacent sizes. The matrix U is a matrix of N×n rows and n columns, as in the following expression.

$$U = ( \begin{matrix}U ( {L}_{1} , {W}_{1} ) \sum ( {L}_{1} , {W}_{1} ) T ( {L}_{1} , {W}_{1} ) \\ ⋮ \\ U ( {L}_{N} , {W}_{N} ) \sum ( {L}_{N } , {W}_{N} ) T ( {L}_{N} , {W}_{N} )\end{matrix} ) \qquad Formula 5$$

Next, the parameter response calculation unit 20 calculates a parameter response of a SPICE model for each device size (step S2004). A description is given below concerning a method of calculating the parameter response.

### Parameter Response

Assuming SPICE parameters (k in number) having variations as Pⱼ, the parameter response can be represented by the following expressions. For example, P₁=VTH0, P₂=U0.

Rᵢⱼ(L,W)=(∂Iᵢ/∂Pⱼ)(L,W) Formula 6

This can be calculated by minutely changing each parameter to view characteristic responses, and Formula 6 can be re-written as in the following expression. Rᵢⱼ(L, W) is a matrix of n rows and k columns.

Rᵢⱼ(L,W)=((Iᵢ(Pⱼ+ΔPⱼ)−Iᵢ(Pⱼ))/ΔPⱼ)(L,W) Formula 7

It is possible to obtain the matrix R by arranging diagonally, in order of device size (N types), Rᵢⱼ(L, W) obtained by the abovementioned expression. The matrix R is a matrix of N×n rows and N×k columns as in the following expression.

$$R = ( \begin{matrix}{R}_{ij} ( {L}_{1} , {W}_{1} ) & 0 & 0 \\ 0 & ⋱ & 0 \\ 0 & 0 & {R}_{ij} ( {L}_{N } , {W}_{N} )\end{matrix} ) \qquad Formula 8$$

Statistical SPICE model parameter calculation processing is performed by the statistical SPICE model parameter calculation unit 40 (step S005).

### Size Dependency

Here, a description is given concerning size dependency of parameters used in calculation of the abovementioned statistical SPICE model parameters.

The parameter size dependency is a function of size (L, W), and can be considered to be a linear sum of mᵢ items determined in advance, as in the following expression.

$$δ {p}_{i} = {\sum }_{m = 1}^{{m}_{i}} {a}_{im} {f}_{im} ( L , W ) \qquad Formula 9$$

For example, according to Pelgrom's Law of Non-Patent Document 1, with mᵢ=1, fᵢ(L, W)=1/SQRT(LW). (Here, SQRT(X) represents the square root of X). When all SPICE parameters obey Pelgrom's Law, δpᵢ=aᵢ/SQRT(LW) may be assumed.

In a case where it is desired to represent a more complex size dependency, a higher order item with fᵢₘ(L, W) may be considered. For example, concerning VTH0, in a case of f_{VTH0,1}=1/SQRT(LW), f_{VTH0,2}=1/SQRT(L), f_{VTH0,3}=1), it is possible to obtain δVTH0 by the following expression.

$$δ VTH 0 = \frac{{a}_{1}}{\sqrt{LW}} + \frac{{a}_{2}}{\sqrt{L}} + {a}_{3} \qquad Formula 10$$

In the same way, concerning UO, in a case of f_{U0,1}=1/SQRT(LW), f_{U0,2}=1), it is possible to obtain δU0 by the following expression.

$$δ U 0 = \frac{{b}_{1}}{\sqrt{LW}} + {b}_{2} \qquad Formula 11$$

By arranging each item of size dependency expressions determined appropriately as above, it is possible to create a size dependency matrix L(L, W). This matrix L(L, W) is a matrix of k rows and Σmᵢ columns as in the following expression.

$$L ( L , W ) = ( \begin{matrix}{F}_{11} ( L , W ) ⋯ {F}_{1 {m}_{1}} ( L , W ) & 0 & 0 \\ 0 & {F}_{21} ( L , W ) ⋯ {F}_{2 {m}_{21}} ( L , W ) & 0 \\ 0 & 0 & {F}_{k 1} ( L , W ) ⋯ {F}_{k {m}_{k}} ( L , W )\end{matrix} ) \qquad Formula 12$$

For example, if a size dependency matrix L(L, W) is created from the abovementioned Formula 10 and Formula 11, the size dependency matrix is a matrix of 2 rows and 5 columns as follows.

$$L ( L , W ) = ( \begin{matrix}\frac{1}{\sqrt{LW}} & \frac{1}{\sqrt{L}} & 1 & 0 & 0 \\ 0 & 0 & 0 & \frac{1}{\sqrt{LW}} & 1\end{matrix} ) \qquad Formula 13$$

In addition, it is possible to create a matrix L by arranging vertically, in order of device size, the size dependency matrix obtained as described above. The matrix L is a matrix of k×N rows and Σmᵢ columns as in the following expression.

$$L = ( \begin{matrix}L ( {L}_{1} , {W}_{1} ) \\ ⋮ \\ L ( {L}_{N} , {W}_{N} )\end{matrix} ) \qquad Formula 14$$

### Calculation of Statistical SPICE Model Parameter

Using the above matrix, it is possible to obtain a matrix G of m rows and n columns, from the following expression.

$$G = {( {( RL )}^{T} RL )}^{- 1} {( RL )}^{T} U \qquad Formula 15$$

The j-column of this matrix G includes j-th principal component parameters, and a sum of all thereof is represented by the following expression.

$$δ {p}_{k} ( L , W ) = {\sum }_{j = 1}^{N} {\sum }_{m = 1}^{{m}_{i}} {g}_{mj} {f}_{k m} ( L , W ) {x}_{j} \qquad Formula 16$$

Here, with x following N(0, 1), by performing Monte Carlo simulation by SPICE, it is possible to reproduce device variation.

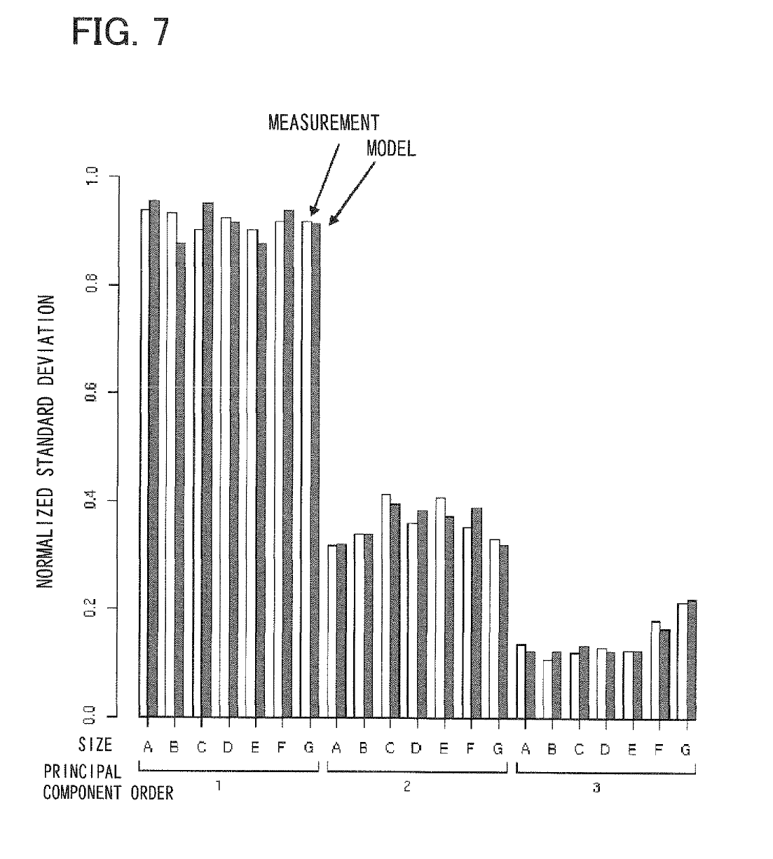

FIG. 7 is a drawing in which variation (model) reproduced using the method of the present exemplary embodiment, and distribution of measured data are plotted for each principal component (as far as the third thereof) and device size (7 types, A to G). As is clear from viewing the same drawing, is it understood that change of element characteristic value due to difference of device size can be closely followed.

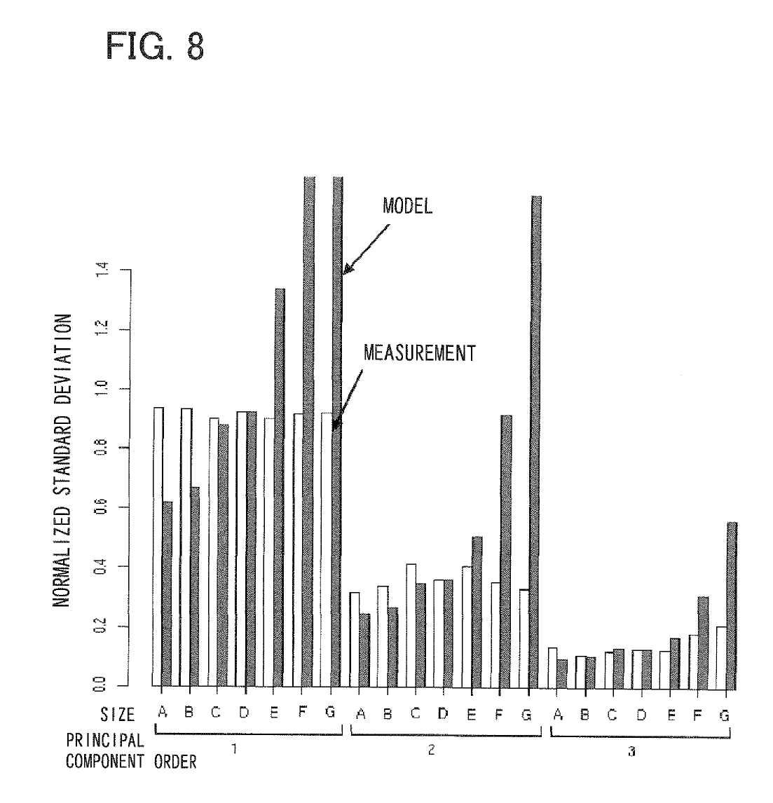

FIG. 8 is a drawing in which variation (model) reproduced by fitting with device size D using the method of Patent Document 2, and distribution of measured data are plotted for each principal component (as far as the third thereof) and device size (7 types, A to G). It is understood that, since fitting is performed with device size D, good reproduction is obtained with device size D, but for sizes that are different, accuracy falls off to a very large extent. In particular, for the first principal component of device sizes F and G, variation to an extent that cannot be fitted into the graph occurs.

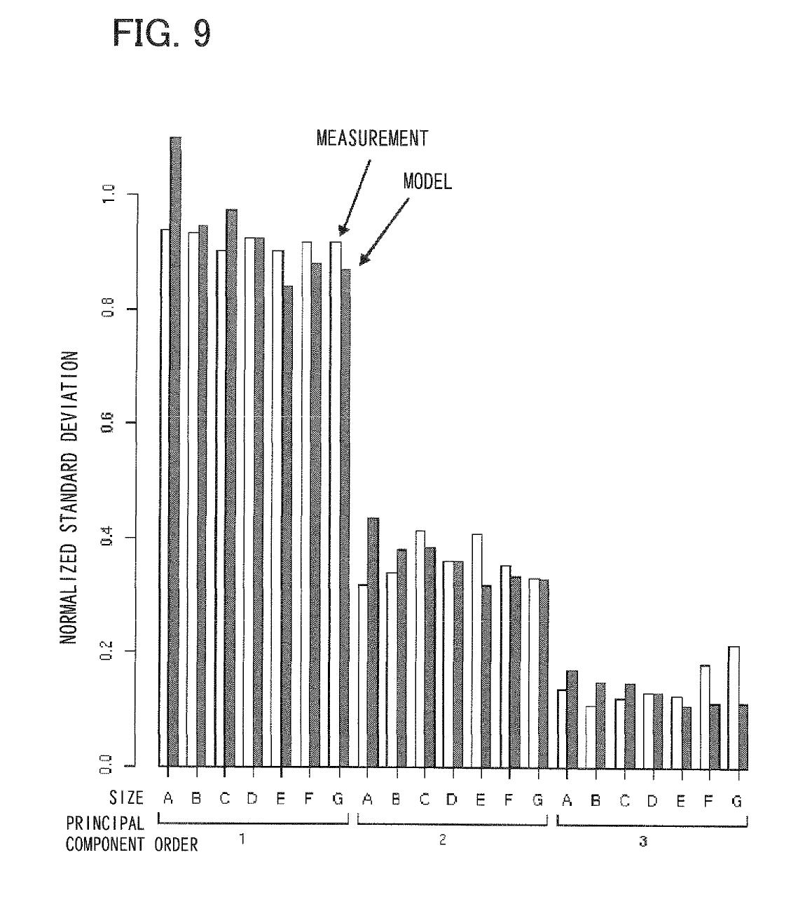

FIG. 9 represents a result of applying a size correction according to Pelgrom's Law of Non-Patent Document 1 to the variation (model) reproduced by fitting with device size D using the method of Patent Document 2. Size dependency is reflected, but with device size A or device size F, G, and the like, it is not possible to follow the measured data.

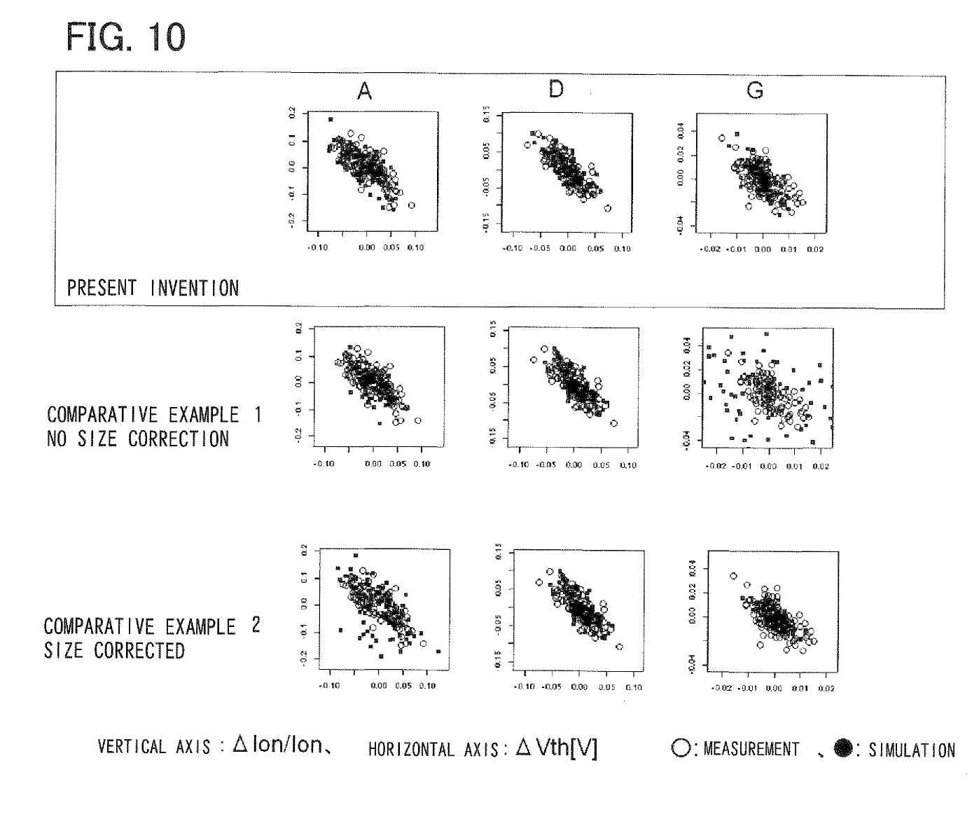

FIG. 10 shows results for which models are formed based on FIG. 7 to FIG. 9, and simulation is performed. In the method of the present invention, in the upper layer, distribution of measured data for all sizes of the device sizes A, D, and G is reproduced, whereas with the device size G of the method (no size correction) of Patent Document 2 in the middle layer, the distribution spreads out to a very large extent. Also in the method (with size correction) of Patent Document 2 in the lower layer, the spread in the second principal component direction with device size A is excessive, and also spread in the first principal component direction with device size G cannot be reproduced.

As described above, according to the present exemplary embodiment of performing adjustment among sizes of the principal component analysis results, it is possible to create a statistical SPICE model parameter that can reproduce the size dependency with high accuracy.

### Second Exemplary Embodiment

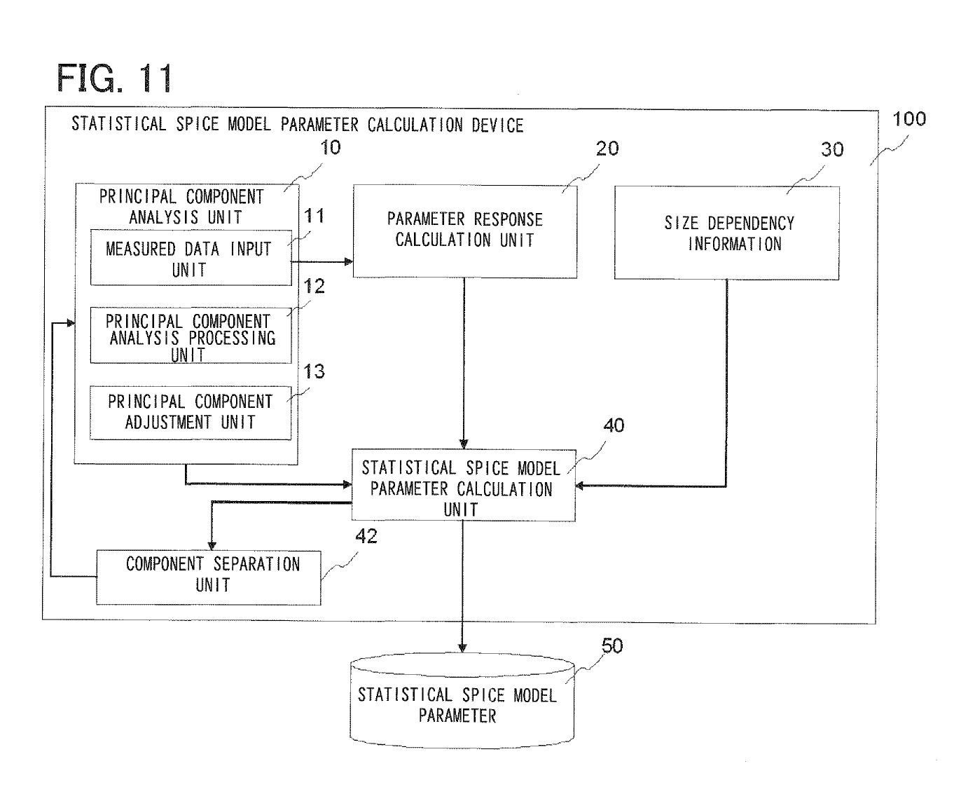

Next, FIG. 11 is a drawing representing a configuration of a statistical SPICE model parameter calculation device according to a second exemplary embodiment of the present invention. A point of difference from the configuration of the first exemplary embodiment shown in FIG. 1 is that a component separation unit 42 is added.

The statistical SPICE model parameter calculation device of the present exemplary embodiment can read data measured by a different target of measurement, and can create a statistical SPICE model parameter of higher accuracy. Below, a description is given concerning a method of raising accuracy of the statistical SPICE model parameter.

Usage may be considered of measured data related to a different characteristic caused by more limited variation, from a measurement target (for example, another wafer) different from the abovementioned measured data Iᵢ(L, W), i=1, . . . , n.

For example, in a case where variation of a device size L, W is measured, the variation of the characteristic L, W is determined by only the variation of the parameters L, W, and does not depend on other variations. With this meaning, a characteristic of the abovementioned type of characteristic L, W is referred to as a “characteristic caused by limited variation”. This target of measurement is written as Jⱼ(for example, J₁=L, J₂=W).

The variation of the abovementioned measured data Iᵢ(L, W) is caused by variation that is common to Jⱼ variation, and is caused by variation specific to Iᵢ(L, W). In the present exemplary embodiment, a Jⱼ variation component is analyzed, items not included in Jⱼ, among variation components of Iᵢ(L,W) are extracted, and a more precise model is created.

For example, in a case where variation of device size L, W is obtained from another wafer, after creating a size variation model, it is possible to create a variation model due to factors outside of size variation.

Specifically, according to a procedure the same as in the first exemplary embodiment described above (refer to FIG. 2), it is possible to finally obtain matrix Gⱼ according to Formula 15 from Jⱼ, and δqⱼ by switching pₖ of Formula 16 to qⱼ. Here, qⱼ is a SPICE parameter, and need not be in the same group as δpₖ described above.

Using a result obtained from the measured data from a different target of measurement as described above, the component separation unit 42 obtains Rⱼ=(∂Iᵢ/∂qⱼ), to be inputted as V_{new}=V−RⱼGⱼ(RⱼGⱼ)^{T} to a principal component analysis unit 10. Here, V is a covariance matrix created from Iᵢ. Using a procedure the same as in the abovementioned first exemplary embodiment (refer to FIG. 2), it is possible to obtain δpᵢ, from V_{new}, and have δpᵢ+δqⱼ as a statistical SPICE model parameter.

### Third Exemplary Embodiment

Next, a description is given concerning a third exemplary embodiment of the present invention in which it is possible to create a detailed model of random variation and variation outside of the random variation. Furthermore, since the present exemplary embodiment can be realized according to a configuration the same as the second exemplary embodiment, a description of the configuration is omitted.

Variations that are not random have correlations for devices that differ outside of L and W. Consequently, data of various sizes taken from one chip are collected into one set and written as Iⱼ. This Iⱼ is taken over a plurality of chips (a plurality within the same wafer face, another wafer, another lot), and it is possible to obtain a covariance matrix Vₐₗₗ from these variations.

However, random variations overlap in this Vₐₗₗ. If a matrix G obtained by a procedure the same as the first and second exemplary embodiment already described above is taken as a random varied G_{ramdom}, variations outside of the random variations can be expressed according to the following formula.

V_{global}=Vₐₗₗ−RG_{random}(RG_{random})^{T} Formula 17

This V_{global} is a covariance matrix of variations outside of the random variations. Using a procedure the same as in the abovementioned first exemplary embodiment on this V_{global} (refer to FIG. 2), it is possible to obtain δp_{global}, and δp_{ramdom}+δp_{global} can be taken as a statistical SPICE model parameter.

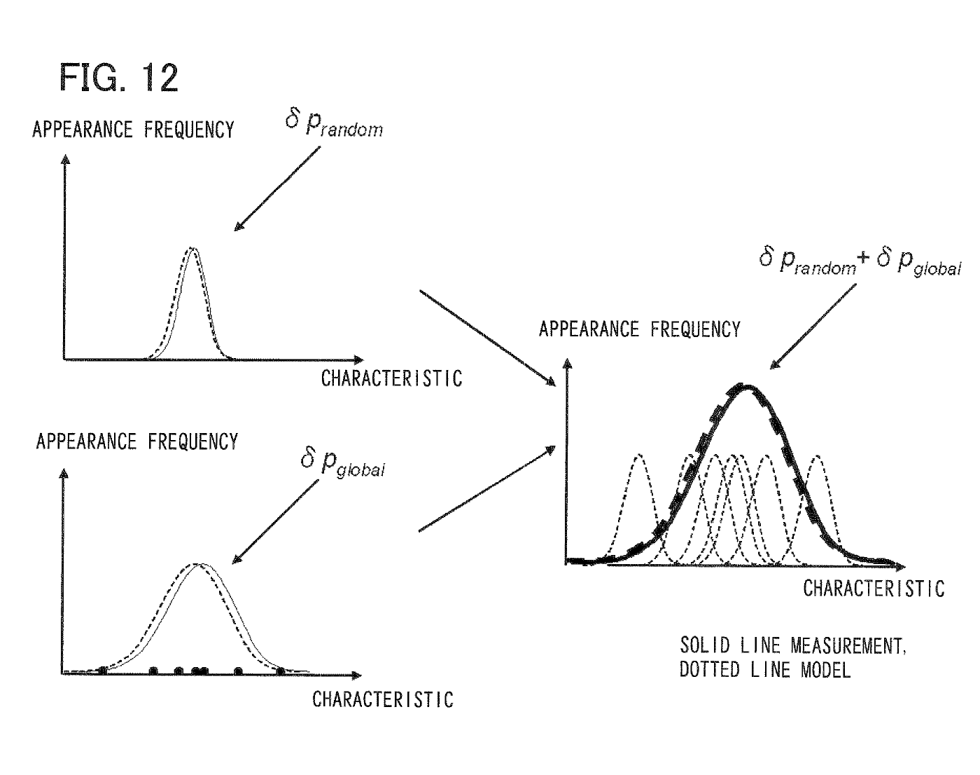

FIG. 12 is a drawing showing an image of δp_{ramdom}+δp_{global}. A histogram in the upper left of FIG. 12 represents the random variation δp_{ramdom} obtained by a procedure the same as in the first and the second exemplary embodiment. A histogram in the lower left of FIG. 12 represents the variation δp_{global} outside of the random variation obtained from the abovementioned V_{global}. The random variation δp_{ramdom} can be modeled by N(μ₁, σ₁²). Furthermore, the variation δp_{global} outside of the random variation can be modeled by N(μ₂,σ₂²) in the same way.

In actuality, since the random variation δp_{ramdom} and the variation δp_{global} outside of the random variation are added, the random variation δp_{ramdom} overlaps with the variation δp_{global} outside of the random variation, as in the right of FIG. 12, and is observed as in the solid line of FIG. 12.

In the present exemplary embodiment, since the abovementioned random variation δp_{ramdom} and the variation δp_{global} outside of this, hidden in the measured data, are separated and modeled, it is possible to reproduce a more accurate model.

A description has been given above concerning preferred exemplary embodiments of the present invention, but the invention is not limited to the abovementioned embodiments and it is possible to add further modifications, substitutions, and adjustments within a scope that does not depart from the fundamental technological concept of the invention. For example, it is possible to add various types of change to numerical formulas and the like introduced in the abovementioned exemplary embodiments.

Furthermore, if a unit that performs circuit simulation using the abovementioned calculated statistical SPICE model parameters is provided in the abovementioned statistical SPICE model parameter calculation device, it is possible to obtain a circuit simulation device that can implement detailed circuit simulation in a short time period. Moreover, it is possible to implement a detailed circuit simulation method using the same device in a short time period.

### Mode 1

In the following, preferred modes are summarized. (refer to the statistical SPICE model parameter calculation method of the first aspect). The statistical SPICE model parameter calculation method is feasible on the statistical SPICE model parameter calculation device of the second aspect and is tied to the device.

### Mode 2

The statistical SPICE model parameter calculation method as defined by mode 1 further comprising a principal component adjustment process of arranging principal component directions of any 2 device sizes obtained by said principal component analysis, and principal component order.

### Mode 3

The statistical SPICE model parameter calculation method as defined by mode 1 or 2, wherein a response of a SPICE model, in a case where a prescribed element characteristic value is changed, is used to calculate said statistical SPICE model parameter.

### Mode 4

The statistical SPICE model parameter calculation method as defined one of modes 1-3, wherein a measurement taken from a different sample is included in measurements of said element characteristic value of said semiconductor device on which multipoint measurement is performed.

### Mode 5

The statistical SPICE model parameter calculation method as defined one of modes 1-4, wherein a measurement taken from said different sample is used to create a variation model according to a common sample variation cause, and a sample-specific variation model, and a parameter obtained from each of said variation models is added to calculate a statistical SPICE model parameter.

### Mode 6

The statistical SPICE model parameter calculation method as defined one of modes 1-5, comprising:

obtaining a random variation statistical SPICE model parameter,

with a variation obtained by deducting said random variation from variation of a measurement obtained from a plurality of samples as input, obtaining a non-random statistical SPICE model parameter, and

calculating a statistical SPICE model parameter that reproduces each of said random variation and said non-random variation.

### Mode 7

(refer to the statistical SPICE model parameter calculation device of the second aspect)

### Mode 8

The statistical SPICE model parameter calculation device as defined by mode 7, further comprising a principal component adjustment unit that arranges principal component directions of any 2 device sizes obtained by said principal component analysis, and principal component order.

### Mode 9

The statistical SPICE model parameter calculation device as defined by mode 7 or 8, wherein said parameter calculation unit uses a response of a SPICE model, in a case where a prescribed element characteristic value is changed, to calculate said statistical SPICE model parameter.

### Mode 10

The statistical SPICE model parameter calculation device as defined by mode one of modes 7-9, further comprising an input unit that inputs a measurement of an element characteristic value of a semiconductor device taken from a different sample.

### Mode 11

The statistical SPICE model parameter calculation device as defined by mode one of modes 7-10, wherein a measurement taken from said different sample is used to create a variation model according to a common sample variation cause, and a sample-specific variation model, and a parameter obtained from each of said variation models is added to calculate a statistical SPICE model parameter.

### Mode 12

The statistical SPICE model parameter calculation device as defined by mode one of modes 7-11, wherein

a random variation statistical SPICE model parameter is obtained from a predetermined sample,

with a variation obtained by deducting said random variation from variation of a measurement obtained from a plurality of samples as input, a non-random variation statistical SPICE model parameter is obtained, and

a statistical SPICE model parameter that reproduces each of said random variation and said non-random variation is calculated.

### Mode 13

(refer to the program of the third aspect). This program is recordable or storable onto a recording medium which is readable by a computer.

### Mode 14

The statistical SPICE model parameter calculation program as defined by mode 13, wherein said program further executes on a computer:

a process of arranging principal component directions of any 2 device sizes obtained by said principal component analysis, and principal component order.

### Mode 15

The statistical SPICE model parameter calculation program as defined by mode 13 or 14, wherein said program further uses a response of a SPICE model, in a case where a prescribed element characteristic value is changed, to calculate said statistical SPICE model parameter.

### Mode 16

The statistical SPICE model parameter calculation program as defined by one of modes 13-15, wherein said program uses a measurement taken from said different sample to create a variation model according to a common sample variation cause, and a sample-specific variation model, and adds a parameter obtained from each of said variation models to calculate a statistical SPICE model parameter.

### Mode 17

The statistical SPICE model parameter calculation program as defined by one of modes 13-16, wherein said program

obtains a random variation statistical SPICE model parameter from a predetermined sample,

with a variation obtained by deducting said random variation from variation of a measurement obtained from a plurality of samples as input, obtains a non-random statistical SPICE model parameter, and

calculates a statistical SPICE model parameter that reproduces each of said random variation and said non-random variation.

### Mode 18

The circuit simulation method that performs circuit simulation by calculating a statistical SPICE model parameter by said statistical SPICE model parameter calculation method as defined by one of modes 1-6, and using said statistical SPICE model parameter.

### Mode 19

The circuit simulation device including said statistical SPICE model parameter calculation device as defined by claim 7-12, wherein circuit simulation is performed using a statistical SPICE model parameter calculated by said statistical SPICE model parameter calculation device.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A statistical SPICE model parameter calculation method comprising:
a principal component analysis process of performing a principal component analysis, for respective device sizes, of a measurement of an element characteristic value of a semiconductor device on which multipoint measurement is performed; and
a parameter calculation process of computing a statistical SPICE model parameter that reproduces variation of an element characteristic value for a plurality of device sizes, based on a result of said principal component analysis obtained for each of said device sizes and a predetermined device size dependency.

2. The statistical SPICE model parameter calculation method according to claim 1, further comprising a principal component adjustment process of arranging principal component directions of any 2 device sizes obtained by said principal component analysis, and principal component order.

3. The statistical SPICE model parameter calculation method according to claim 1, wherein a response of a SPICE model, in a case where a prescribed element characteristic value is changed, is used to calculate said statistical SPICE model parameter.

4. The statistical SPICE model parameter calculation method according to claim 1, wherein a measurement taken from a different sample is included in measurements of said element characteristic value of said semiconductor device on which multipoint measurement is performed.

5. The statistical SPICE model parameter calculation method according to claim 1, wherein a measurement taken from said different sample is used to create a variation model according to a common sample variation cause, and a sample-specific variation model, and a parameter obtained from each of said variation models is added to calculate a statistical SPICE model parameter.

6. The statistical SPICE model parameter calculation method according to claim 1, comprising:
obtaining a random variation statistical SPICE model parameter,
with a variation obtained by deducting said random variation from variation of a measurement obtained from a plurality of samples as input, obtaining a non-random statistical SPICE model parameter, and
calculating a statistical SPICE model parameter that reproduces each of said random variation and said non-random variation.

7. A statistical SPICE model parameter calculation device comprising:
a principal component analysis unit that performs principal component analysis, for respective device sizes, of a measurement of an element characteristic value of a semiconductor device on which multipoint measurement is performed; and
a parameter calculation unit that calculates a statistical SPICE model parameter which reproduces variation of an element characteristic value for a plurality of device sizes, based on a result of said principal component analysis obtained for each of said device sizes, and a predetermined device size dependency.

8. The statistical SPICE model parameter calculation device according to claim 7, further comprising a principal component adjustment unit that arranges principal component directions of any 2 device sizes obtained by said principal component analysis, and principal component order.

9. The statistical SPICE model parameter calculation device according to claim 7, wherein said parameter calculation unit uses a response of a SPICE model, in a case where a prescribed element characteristic value is changed, to calculate said statistical SPICE model parameter.

10. The statistical SPICE model parameter calculation device according to claim 7, further comprising an input unit that inputs a measurement of an element characteristic value of a semiconductor device taken from a different sample.

11. The statistical SPICE model parameter calculation device according to claim 7, wherein a measurement taken from said different sample is used to create a variation model according to a common sample variation cause, and a sample-specific variation model, and a parameter obtained from each of said variation models is added to calculate a statistical SPICE model parameter.

12. The statistical SPICE model parameter calculation device according to claim 7, wherein
a random variation statistical SPICE model parameter is obtained from a predetermined sample,
with a variation obtained by deducting said random variation from variation of a measurement obtained from a plurality of samples as input, a non-random variation statistical SPICE model parameter is obtained, and
a statistical SPICE model parameter that reproduces each of said random variation and said non-random variation is calculated.

13. A statistical SPICE model parameter calculation program coupled with a computer memory that executes on a computer:
a process of performing a principal component analysis, for respective device sizes, of a measurement of an element characteristic value of a semiconductor device on which multipoint measurement is performed; and
a process of calculating a statistical SPICE model parameter that reproduces variation of an element characteristic value for a plurality of device sizes, based on a result of said principal component analysis obtained for each of said device sizes, and a predetermined device size dependency.

14. The statistical SPICE model parameter calculation program according to claim 13, wherein said program further executes on a computer:
a process of arranging principal component directions of any 2 device sizes obtained by said principal component analysis, and principal component order.

15. The statistical SPICE model parameter calculation program according to claim 13, wherein said program further uses a response of a SPICE model, in a case where a prescribed element characteristic value is changed, to calculate said statistical SPICE model parameter.

16. The statistical SPICE model parameter calculation program according to claim 13, wherein said program uses a measurement taken from said different sample to create a variation model according to a common sample variation cause, and a sample-specific variation model, and adds a parameter obtained from each of said variation models to calculate a statistical SPICE model parameter.

17. The statistical SPICE model parameter calculation program according to claim 13, wherein said program
obtains a random variation statistical SPICE model parameter from a predetermined sample,
with a variation obtained by deducting said random variation from variation of a measurement obtained from a plurality of samples as input, obtains a non-random statistical SPICE model parameter, and
calculates a statistical SPICE model parameter that reproduces each of said random variation and said non-random variation.

18. A circuit simulation method that performs circuit simulation by calculating a statistical SPICE model parameter by said statistical SPICE model parameter calculation method according to claim 1, and using said statistical SPICE model parameter.

19. A circuit simulation device including said statistical SPICE model parameter calculation device according to claim 7, wherein circuit simulation is performed using a statistical SPICE model parameter calculated by said statistical SPICE model parameter calculation device.
